(19) United States
(12) Patent Application Publication
(10) Pub. No.: US 2025/0379248 A1
(43) Pub. Date: Dec. 11, 2025

(54) ELECTRODE ASSEMBLY AND BATTERY CELL HAVING THE SAME

(71) Applicant: SK On Co., Ltd., Seoul (KR)

(72) Inventor: Won Je OH, Daejeon (KR)

(21) Appl. No.: 19/204,634

(22) Filed: May 12, 2025

(30) Foreign Application Priority Data
Jun. 11, 2024 (KR) 10-2024-0075699

(51) Int. Cl. H01M 10/04

(52) U.S. Cl. CPC H01M 10/0431; H01M 10/0422

(57) ABSTRACT

An embodiment of the present disclosure can provide an electrode assembly, comprising: a first electrode wound about a winding axis and comprising a first uncoated portion a second electrode wound about the winding axis and comprising a second uncoated portion, and a separator disposed between the first electrode and the second electrode; wherein the first uncoated portion comprises a plurality of cutting portions, formed at a predetermined depth from an end of the first electrode, and a plurality of cross-cutting portions, extending from the cutting portions and formed in a winding direction.

### CROSS-REFERENCE TO RELATED PATENT APPLICATION

The present application claims priority under 35 U.S.C. § 119 (a) to Korean patent application number 10-2024-0075699 filed on Jun. 11, 2024, in the Korean Intellectual Property Office, the entire disclosure of which is incorporated by reference herein.

### BACKGROUND OF THE INVENTION

### 1. Field

The present disclosure relates to an electrode assembly and a battery cell.

### 2. Description of the Related Art

In the conventional cylindrical battery cell, a strip-shaped electrode tab is connected to the uncoated portion of the positive electrode and the uncoated portion of the negative electrode, respectively, and the electrode tab is connected with an electrode terminal and a case. A battery cell having such a structure has a problem of high resistance, high heat generation, and poor current collection efficiency because current is concentrated on a strip-shaped electrode tab that is coupled to the uncoated portion of the positive electrode and/or to the uncoated portion of the negative electrode.

On the other hand, in order to solve this problem, a tab-less battery cell in which the uncoated portion of the positive electrode and the uncoated portion of the negative electrode are disposed at an upper end and a lower end of a jelly roll type electrode assembly, respectively, and a current collecting plate is welded to these uncoated portions is presented. In the case of the above tap-less battery cell, in order to increase the welding area, each of the above uncoated portions is bent and then welded with a current collecting plate.

However, in the process of winding the electrode assembly after bending the uncoated portion, the bent uncoated portion can be unfolded again due to the winding curvature. When the bent uncoated portion is unfolded again, the bent uncoated portion may not be able to maintain a uniform shape, and the uncoated portions may protrude irregularly. This may result in a problem in that the subsequent process of flattening the bent uncoated portion in a uniform form may not be stably performed. In addition, if the bent uncoated portion cannot be evenly flattened, the welding quality between the bent uncoated portion and the current collecting plate may be degraded, thereby increasing the defect rate of the battery cell to be manufactured.

### SUMMARY OF THE INVENTION

One aspect of the present disclosure provides an electrode assembly and a battery cell which may be capable of improving process stability.

Another aspect of the present disclosure provides the electrode assembly and the battery cell which may be capable of improving welding quality.

Another aspect of the present disclosure provides the electrode assembly and the battery cell which may be capable of reducing a defect rate.

The present disclosure can be widely applied in the field of electric vehicles, battery charging stations, and green technology, such solar power generation, and wind power generation using batteries. In addition, the present disclosure can be used in eco-friendly electric vehicles, hybrid vehicles, etc. to prevent climate change by suppressing air pollution and greenhouse gas emissions.

An electrode assembly according to an embodiment of the present disclosure comprises a first electrode wound about a winding axis and including a first uncoated portion; a second electrode wound about the winding axis and including a second uncoated portion, and a separator disposed between the first electrode and the second electrode, wherein the first uncoated portions may comprise a plurality of cutting portions, formed at a predetermined depth from an end portion of the first electrode, and a plurality of cross-cutting portions, extending from the cutting portions and formed in a winding direction.

In one embodiment, a shape formed by the cutting portion and the cross-cutting portion may be a T shape or a + shape.

In one embodiment, a cutting depth a of the cutting portion may be in the range of 1 mm or more and 7 mm or less.

In one embodiment, a cutting depth b of the cross-cutting portion extending from the cutting portion may be in the range of 0.5 mm or more and 2.5 mm or less.

In one embodiment, the first uncoated portion may comprise a plurality of flags partitioned by the cutting portion and the cross-cutting portion.

In one embodiment, the flag comprises a bent portion connected to the first uncoated portion, and a width c of the bent portion may be in the range of 1 mm or more and 5 mm or less.

In one embodiment, a ratio b/d of the cutting depth b of the cross-cutting portion extending from the cutting portion to a width d of the flag may be in the range of 0.08 or more and 0.85 or less.

In one embodiment, a ratio c/d of a width c of the cutting portion to a width d of the flag may be in the range of 0.08 or more and 0.85 or less.

In one embodiment, a spacing x between the flag and an adjacent flag may be in the range of 100 μm or less.

In one embodiment, the plurality of flags may be bent toward the winding axis, and at least one of the bent flags may be arranged to overlap each other.

In one embodiment, the second uncoated portion may comprise a plurality of cutting portions, formed at a predetermined depth from an end portion of the second electrode, and a plurality of cross-cutting portions, extending from the cutting portions and formed in a winding direction.

A battery cell according to another embodiment of the present disclosure comprises the electrode assembly described above; and a cylindrical case housing the electrode assembly.

### BRIEF DESCRIPTION OF THE DRAWINGS

FIG. 1 is a perspective view schematically illustrating an electrode assembly according to an embodiment of the present disclosure.

FIG. 2 is a plan view schematically showing the shape of the electrode assembly of FIG. 1 before winding.

FIG. 3 is an enlarged view of the area A of FIG. 2.

FIG. 4 is a diagram showing a modified form of FIG. 3.

FIG. 5 is a perspective view schematically illustrating a wound shape of an electrode assembly according to an embodiment of the present disclosure.

FIG. 6 is an enlarged view of the area B of FIG. 5.

### DETAILED DESCRIPTION

Hereinafter, the present disclosure will be described in detail with reference to the attached drawings. This is merely illustrative, and the present disclosure is not limited to the specific embodiments described in an illustrative manner.

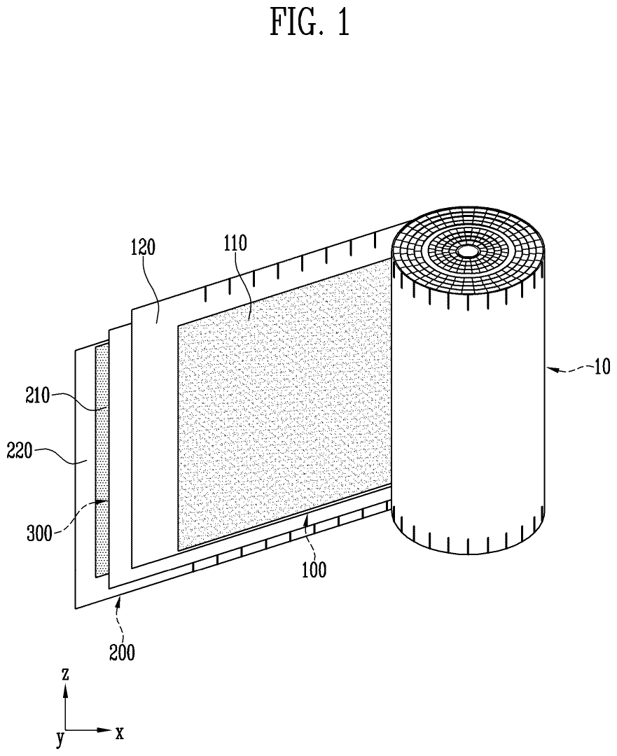

The present disclosure relates to an electrode assembly. FIG. 1 is a perspective view schematically illustrating an electrode assembly according to the present disclosure. Referring to FIG. 1, the electrode assembly 10 according to the present disclosure comprises a first electrode 100 wound about a winding axis and including a first uncoated portion 120; a second electrode 200 wound about the winding axis and including a second uncoated portion 220; and a separator 300 disposed between the first electrode 100 and the second electrode 200, and the first uncoated portions 120 may include a plurality of cutting portions 121 formed at a predetermined depth from an end portion of the first electrode 100, and cross-cutting portions 122 extending from the cutting portions 121 and formed in a winding direction.

The battery cell may be provided by accommodating, in a cylindrical battery case, an electrode assembly prepared by stacking and winding the positive electrode, the separator, and the negative electrode. At this time, the uncoated portion of the positive electrode and/or the negative electrode is bent and then wound to manufacture the electrode assembly, and the curvature formed during winding may cause a problem that the uncoated portions of the bent positive and/or negative electrodes are stretched again, or the shape of the bent uncoated portions is irregularly deformed. Such a problem may degrade the stability of the subsequent process, may degrade the welding quality of the bent uncoated portion and the current collecting plate, and may cause a problem in that the defect rate of the battery cell to be manufactured is increased. In contrast, in the electrode assembly according to the present disclosure, the first uncoated portion includes the cutting portion and the cross-cutting portion, so that the above problems that occur in the uncoated portion during winding can be solved.

The electrode assembly 10 according to the present disclosure may include the first electrode 100 including the first uncoated portion 120 and the second electrode 200 including the second uncoated portion 220.

The first electrode 100 may include a first current collector, a first active material layer 110, and the first uncoated portion 120. The first current collector may be, but is not limited to, a metal foil such as copper or aluminum. The first active material layer 110 may be formed on at least one surface of the first current collector, and may be disposed in contact with the first current collector.

The first uncoated portion 120 may mean a region where the first active material layer 110 is not disposed on the first current collector of the first electrode 100. The first uncoated portion 120 may be disposed on one or more of the two long sides of the first electrode 100, but is not limited thereto. The first uncoated portion 120 may serve as an electrode tab in the battery cell described below.

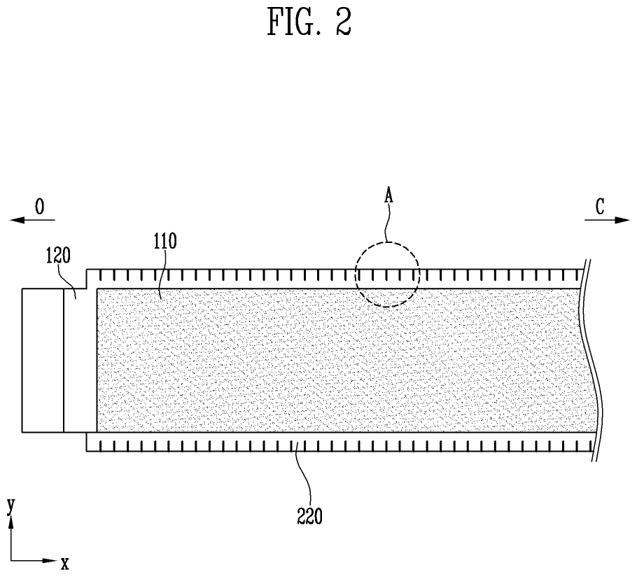

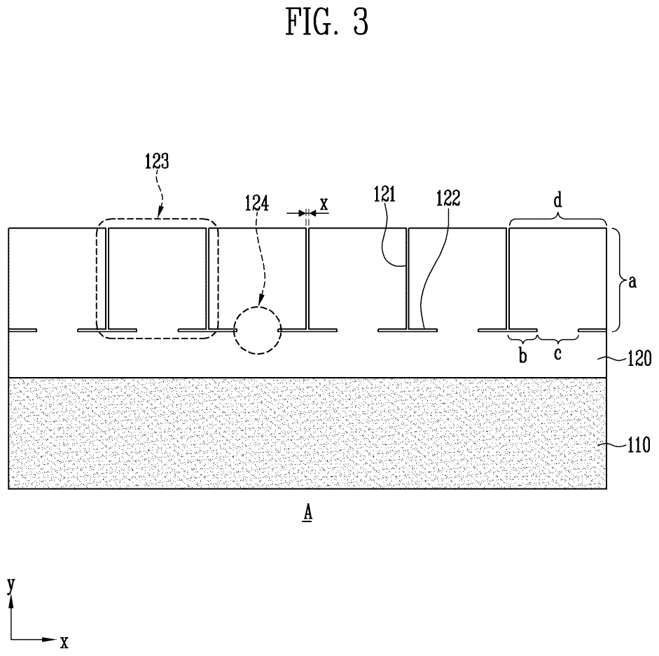

The first uncoated portion 120 may include a plurality of cutting portions 121 formed at a predetermined depth from the end of the first electrode 100 and cross-cutting portions 122 extending from the cutting portions 121 and formed in the winding direction. FIG. 2 is a plan view schematically showing the shape of the electrode assembly 10 of FIG. 1 before winding, and FIG. 3 is an enlarged view of the area A of FIG. 2. Referring to FIGS. 2 and 3, the first uncoated portion 120 of the electrode assembly 10 according to the present disclosure may include a plurality of cutting portions 121 formed at a predetermined depth from the end of the first electrode 100, and may include a plurality of cross-cutting portions 122 extending from the cutting portions.

In one embodiment of the present disclosure, a shape formed by the cutting portion 121 and the cross-cutting portion 122 of the electrode assembly 10 according to the present disclosure may be a T shape or a + shape. Referring to FIG. 3, the cutting portion 121 included in the first uncoated portion 120 of the electrode assembly 10 according to the present disclosure, and the cross-cutting portion 122 formed extending from the cutting portion 121 may have a T-shape. The fact that the cutting portion 121 and the cross-cutting portion 122 form a T-shape may mean that the cross-cutting portion 122 is formed at the end of the cutting portion 121, and may mean that the above-described cross-cutting portions 122 are formed in the winding direction from the end of the above-described cutting portion 121. When the cutting portion 121 and the cross-cutting portion 122 of the electrode assembly 10 according to the present disclosure form a T-shape, the bent portion described below can be uniformly formed, and the bent portion can be prevented from being unfolded.

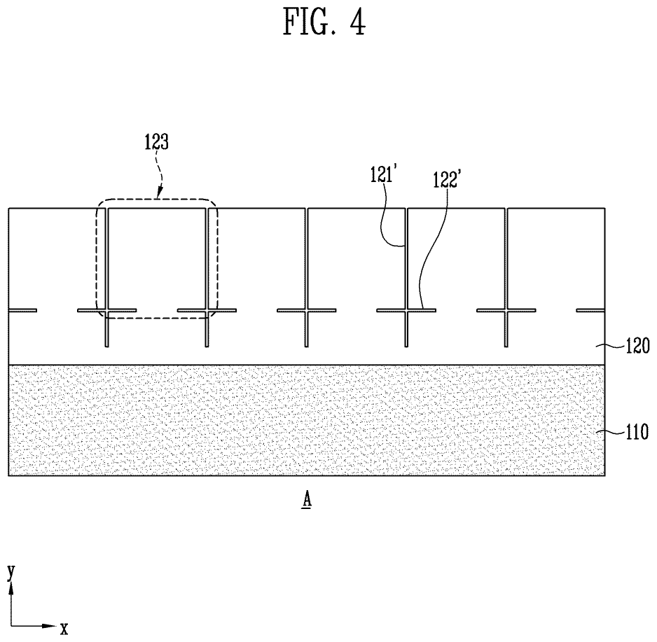

In another embodiment of the present disclosure, the shape formed by the cutting portion and the cross-cutting portion of the electrode assembly according to the present disclosure may be a + shape. FIG. 4 is a plan view schematically showing a modified form of the electrode assembly 10 of FIG. 3. Referring to FIG. 4, the cutting portion 121′ included in the first uncoated portion 120 of the electrode assembly 10 according to the present disclosure and the cross-cutting portion 122′ formed extending from the cutting portion 121′ may have a T-shape. The fact that the cutting portion 121′ and the cross-cutting portion 122′ have a positive shape may mean that the cross-cutting portion 122′ is formed at a position shallower than the depth of the cutting portion 121, and may mean that the crossed-cutting portion 123′ is formed between the end of the first electrode 100 and the end of the cutting portion 122′. When the cut portion 121′ and the cross-cutting portion 122′ of the electrode assembly 10 according to the present disclosure form a + shape, shape deformation during bending of the flag described below can be minimized.

In one embodiment, the cutting depth a of the cutting portion 121 of the electrode assembly 10 according to the present disclosure may be in the range of 2 mm or more and 7 mm or less. The cutting depth a − of the cutting portion 121 may mean the arithmetic mean of the cutting depths of the plurality of cutting portions. The cutting depth a of the cutting portion 121 may be 2.0 mm or more, 2.2 mm or more, 2.4 mm or more, 2.6 mm or more, 2.8 mm or more, or 3.0 mm or more, and may be 7.0 mm or less, 6.5 mm or less, 6.0 mm or less, 5.5 mm or less, or 5.0 mm or less, but is not limited thereto. The size of the flag described below may be determined according to the cutting depth a of the cutting portion 121.

When the cutting depth a of the cutting portion 121 of the electrode assembly 10 according to the present disclosure is too shallow, the formed flag is too short to fold the flag, the number of electrically connected flags when connected to the current collecting plate is small, the resistance may increase, and the welding quality with the current collecting plate may decrease. In addition, if the cutting depth a of the cutting portion 121 of the electrode assembly 10 is too deep, it may be difficult to make the flags in a state with a certain angle before the flattening process, which may make it difficult to perform the stiffening process. In addition, when the flag described below is bent, a region that is too close to the active material layer is bent, which may cause a defect in the battery cell to be manufactured, and a part of the bent flag may not have a uniform shape and may protrude.

In another embodiment, the cutting depth b of the cross-cutting portion 122 extending from the cutting portion 121 of the electrode assembly 10 according to the present disclosure may be in the range of 0.5 mm or more and 2.5 mm or less. The cutting depth b of the cross-cutting portion 122 may mean a length measured from a point where the cutting portion 121 and the cross-cutting portion 122 are in contact to any one end of the cross-cutting portion 122. The cutting depth b of the cross-cutting portion 122 may also mean an arithmetic mean of the lengths of the plurality of cross-cutting portions 122.

When the cutting depth b of the cross-cutting portion 122 of the electrode assembly 10 according to the present disclosure is too shallow, the folded structure of the flag may not be stabilized during winding of the electrode assembly, and a problem may occur in that the bent flag is unfolded again due to curvature. In addition, when the cutting depth b of the cross-cutting portion 122 is too deep, the bent portion described later may not have a sufficient width, and mechanical strength may be reduced, making it difficult to control the shape of the flag, or electrical connectivity may be reduced.

In one embodiment of the present disclosure, the first uncoated portion 120 of the electrode assembly 10 according to the present disclosure may include a plurality of flags 123 partitioned by cutting portions 121 and cross-cutting portions 122. Referring to FIG. 3, the first uncoated portion 120 of the electrode assembly 10 may include a plurality of cutting portions 121 and a plurality of cross-cutting portions 122, and may include the plurality of flags 123 defined by the cutting portions 121 and the cross-cutting portion 122. The flag 123 may serve as an electrode tab of the electrode assembly, and the electrode assembly 10 according to the present disclosure may be welded to a current collecting plate through the flag 123.

In one embodiment of the present disclosure, the flag 123 of the electrode assembly 10 according to the present disclosure includes a bent portion 124 connected to the first uncoated portion 120, and a width c of the bent portion 124 may be in the range of 1 mm or more and 5 mm or less. Referring to FIG. 3, the flag 123 of the electrode assembly 10 according to the present disclosure may include the bent portion 124, and the flag 123 may be connected to the first uncoated portion 120 through the bent portion 124. The width c of the bent portion 124 may mean the arithmetic mean of the widths of the plurality of bent portions 124.

When the width c of the bent portion 124 of the electrode assembly 10 according to the present disclosure is too narrow, the connection strength between the flag 123 and the first uncoated portion 120 is lowered, so that the flag may be broken due to an external impact or the like, and the width of the electrical connection passage is narrowed, so that the resistance of the cell is increased, and energy loss may occur. In addition, if the width c of the bent portion 124 of the electrode assembly 10 is too wide, the folded structure of the flag may not be stabilized when the electrode assembly 10 winds up, and the bent flag 123 may be re-stretched due to curvature, or the shape of the bent flag 123 becomes irregular.

In one embodiment, the ratio b/d of the cutting depth b of the cross-cutting portion 122 extending from the cutting portion 121 to the width d of the flag 123 of the electrode assembly 10 according to the present disclosure may be in the range of 0.08 or more and 0.85 or less. The ratio b/d of the cutting depth b of the cross-cutting portion 122 extending from the cutting portion 121 to the width d of the flag 123 may mean an arithmetic average of the ratio b/d, of the width d, of the plurality of flags 123 and of the cutting depths b of a plurality of cross-cutting portions 122. When the ratio b/d of the cutting depth b of the cross-cutting portion 122 to the width d of the flag 123 of the electrode assembly 10 according to the present disclosure satisfies the above range, the welding quality of the battery cell including the electrode assembly 10 can be improved and the stability of the manufacturing process can be improved.

In another embodiment, the ratio c/d of the width c of the cutting portion 121 to the width d of the flag 123 of the electrode assembly 10 according to the present disclosure may be in the range of 0.08 or more and 0.85 or less. The ratio c/d of the width c of the cutting portion 121 to the width d of the flag 123 may mean an arithmetic average of the ratio of the widths d of the plurality of flags 123 and the widths c of the plurality of cutting portions 121. If the ratio c/d of the width c of the cutting portion 121 to the width d of the flag 123 is too low, the mechanical strength of the battery cell including the electrode assembly 10 may decrease or the resistance may increase. In addition, when the ratio c/d of the width c of the cutting portion 121 to the width d of the flag 123 is too high, the stability of the compaction process with respect to the flag 123 may decrease, and the defect rate of the battery cell including the electrode assembly 10 may increase.

In an embodiment of the present disclosure, the spacing x between the flag 123 of the electrode assembly 10 according to the present disclosure and the adjacent flag 123 may be in the range of 100 μm or less. Referring to FIG. 3, the spacing x between the flags 123 may mean the shortest distance between the flag 123 of the electrode assembly 10 and the flag 123 adjacent to the flag 123, and may mean the width of the cutting portion 121 described above. The spacing x between the flag 123 and the adjacent flag 123 may also mean an arithmetic mean of the distances between the plurality of flags 123. The lower limit of the distance x between the flag 123 and the adjacent flag 123 is not particularly limited, but may be, for example, 2 μm or more, 3 μm or more 4 μm or more or 5 um or more. When the spacing x between the flag 123 and the adjacent flag 123 of the electrode assembly 10 according to the present disclosure satisfies the above range, the battery cell including the electrode assembly 10 may have low electrical resistance along with high welding quality. In addition, if the spacing x between the flag 123 and the adjacent flag 123 of the electrode assembly 10 according to the present disclosure is too wide, a part of the uncoated portion may fall off when the flag is formed, and defects may occur in the notching process due to foreign substances generated.

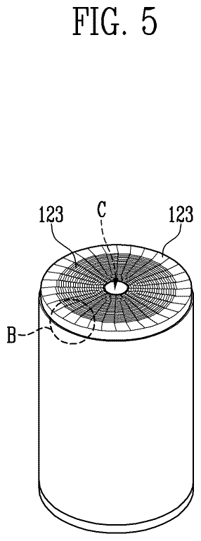

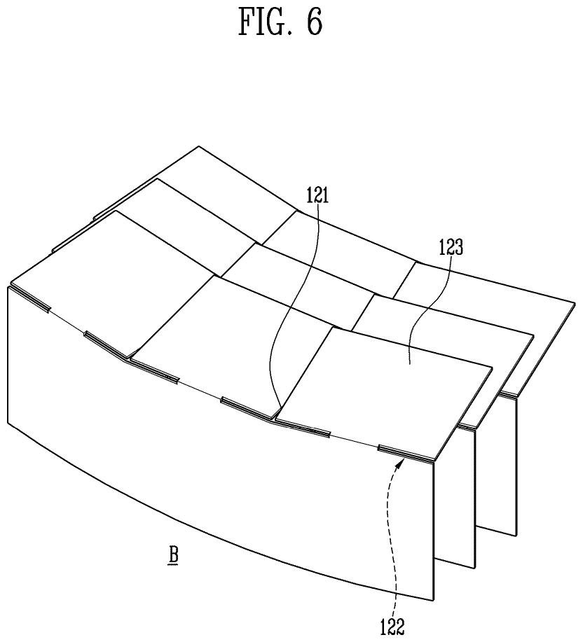

In one embodiment, the plurality of flags 123 of the electrode assembly 10 according to the present disclosure may be bent toward the winding axis, and at least some of the bent flags 123 may be disposed to overlap each other. FIG. 5 is a perspective view schematically showing the electrode assembly 10 in which a plurality of flags 123 are bent, and FIG. 6 is an enlarged view of the region B of FIG. 5. Referring to FIGS. 5 and 6, a plurality of flags 123 of an electrode assembly 10 according to the present disclosure may be bent toward a winding axis C of the electrode assembly 10. The plurality of flags 123 may be bent before winding the electrode assembly 10, or may be bent during winding, and may be completely bent by a hardening process after winding. As shown in FIG. 6, the plurality of bent flags 123 may be arranged such that at least some of them overlap each other due to the winding curvature. Specifically, the plurality of bent flags 123 may be arranged such that regions close to the winding axis C overlap each other. The plurality of flags 123 are bent so as to overlap each other, whereby the contact area between the plurality of flags 133 and the current collecting plate can be increased, and the resistance of the battery cell including the electrode assembly 10 can be reduced.

The electrode assembly 10 according to the present disclosure may include the first electrode 100 including the first uncoated portion 120, the second electrode 200 including the second uncoated portion 220, and the separator 300 disposed between the first electrode 100 and the second electrode 200.

The second electrode 200 may include a second current collector, a second active material layer 210, and the second uncoated portion 220. The second current collector may be, but is not limited to, a metal foil such as copper or aluminum. The second active material layer 210 may be formed on at least one surface of the second current collector, and may be disposed in contact with the second current collector.

The second uncoated portion 220 may mean a region where the second active material layer 210 is not disposed on the second current collector of the second electrode 200. The second uncoated portion 220 may be disposed on one or more of the two long sides of the second electrode 200, but is not limited thereto. The second uncoated portion 220 may serve as an electrode tab in a battery cell described below.

In one embodiment, the second electrode of the electrode assembly according to the present disclosure may have the same configuration as one or more of the configurations of the first electrode described above. For example, the second uncoated portion of the second electrode of the electrode assembly according to the present disclosure may include a plurality of cutting portions formed at a predetermined depth from the end of the second electrode, and a plurality of cross-cutting portions extending from the cutting portions and formed in the winding direction. In addition, one or more of the contents of the first uncoated portion of the first electrode, the cutting portion, the cross-cutting portion, the bent portion, and the flag of the first uncoated portion may be applied to the second uncoated portion, the cutting portion of the second uncoated portion, the cross-cutting portion, the bent region, and the flag.

The descriptions of the second electrode, the second uncoated portion, and the like are the same as those of the first electrode, the second uncoated portion, or the like described above, and thus will be omitted.

The separation membrane 300 may refer to a membrane that physically separates the first electrode and the second electrode. The separation membrane 300 may be an insulating film, and may include a polymer film, a porous nonwoven fabric, or the like, but is not limited thereto. The electrode assembly according to the present disclosure may have a structure in which a first electrode, a separation membrane 300, and a second electrode are stacked.

In one embodiment of the present disclosure, the first electrode of the electrode assembly according to the present disclosure may be a positive electrode, and the second electrode may be a negative electrode, and in this case, the first active material layer may include a positive active material, and the second active material layer may also include a negative active material, but the present disclosure is not limited thereto.

The present disclosure also relates to a battery cell. The battery cell according to another embodiment of the present disclosure may include the electrode assembly described above and a cylindrical case housing the electrode assembly.

The cylindrical case of the battery cell according to the present disclosure includes an opening portion having an opening on one surface, and the electrode assembly can be accommodated therein through the opening portion. The electrode assembly accommodated in the case may be wound in the form of a roll and accommodated inside the case.

In one embodiment, the battery cell according to the present disclosure may further include a first electrode current collecting plate disposed adjacent to the first uncoated portion and/or a second electrode current collecting plate arranged adjacent to the second uncoated portion of the electrode assembly. The first electrode current collecting plate and the second electrode current collecting plate may be made of a metal material such as aluminum or copper, but are not limited thereto.

In another embodiment, when the battery cell according to the present disclosure includes the first electrode current collecting plate and/or the second electrode current collecting plate, the first electrode current collecting plate and/or second current collecting plate may include a through hole penetrating along the winding axis. The through hole may be disposed in a central portion of the first electrode current collecting plate and/or the second electrode current collecting plate, and may be disposed at a position corresponding to the hollow of the core portion of the electrode assembly. The through-hole may function as an injection hole for injecting the electrolyte in the manufacturing process of the battery cell.

In an embodiment of the present disclosure, the battery cell according to the present disclosure may further include a cap plate disposed on the opening of the case. The cap plate may serve to seal the opening of the case.

The cap plate may include an electrode terminal disposed at a central portion. The electrode terminal may be electrically connected to the first electrode. One end of the electrode terminal may be connected to the first electrode current collecting plate through a central portion of the cap plate. In addition, the electrode terminal and the first electrode current collecting plate may be directly connected to each other or electrically connected to each other through a separate connection electrode, but the present invention is not limited thereto. The other end of the electrode terminal connected to the first electrode current collecting plate may be disposed to protrude outward of the cap plate and may function as an external terminal.

In an embodiment of the present disclosure, the second electrode current collecting plate of the battery cell according to the present disclosure may be electrically connected to the above case. The second electrode current collecting plate may have a structure extending outward from the winding center of the electrode assembly, and may have a structure in direct contact with the case in an outward direction of the structure.

In another embodiment, the battery cell according to the present disclosure may further include a second electrode current collecting plate and a connecting member (not shown) disposed between the second electrode current collecting plates and the case. When the battery cell according to the present disclosure further includes a connecting member (not shown), the second electrode current collecting plate and the case may be electrically connected through the connecting member (not shown).

On the other hand, the case of the battery cell according to the present disclosure may have a beading portion formed at the end portion on the side of the opening portion, and the electrode assembly of the battery cell may be fixed by the beading portion.

According to an embodiment of the present disclosure, it is possible to provide the electrode assembly and the battery cell capable of improving process stability.

According to another embodiment of the present disclosure, it is possible to provide the electrode assembly and the battery cell capable of improving welding quality.

According to another embodiment of the present disclosure, it is possible to provide the electrode assembly and the battery cell capable of reducing a defect rate.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. An electrode assembly comprising:
a first electrode wound about a winding axis and including a first uncoated portion;
a second electrode wound about the winding axis and including a second uncoated portion; and
a separator disposed between the first electrode and the second electrode;
wherein the first uncoated portion comprises a plurality of cutting portions, formed at a predetermined depth from an end of the first electrode, and a plurality of cross-cutting portions, extending from the cutting portions and formed in a winding direction.

2. The electrode assembly according to claim 1, wherein a shape formed by the cutting portion and the cross-cutting portion is a T shape or a + shape.

3. The electrode assembly according to claim 1, wherein a cutting depth a of the cutting portion is in the range of 2 mm or more and 7 mm or less.

4. The electrode assembly according to claim 1, wherein a cutting depth b of the cross-cutting portion extending from the cutting portion is in the range of 0.5 mm or more and 2.5 mm or less.

5. The electrode assembly according to claim 1, wherein the first uncoated portion comprises a plurality of flags partitioned by the cutting portion and the cross-cutting portion.

6. The electrode assembly according to claim 5, wherein the flag comprises a bent portion connected to the first uncoated portion, and
a width c of the bent portion is in the range of 1 mm or more and 5 mm or less.

7. The electrode assembly according to claim 5, wherein a ratio b/d of a cutting depth b of the cross-cutting portion extending from the cutting portion to a width d of the flag is in the range of 0.08 or more and 0.85 or less.

8. The electrode assembly according to claim 5, wherein a ratio c/d of a width c of the cutting portion to a width d of the flag is in the range of 0.08 or more and 0.85 or less.

9. The electrode assembly according to claim 5, wherein a spacing x between the flag and adjacent the flag is in the range of 100 μm or less.

10. The electrode assembly according to claim 1, wherein the second uncoated portion comprises a plurality of cutting portions, formed at a predetermined depth from an end of the second electrode, and a plurality of cross-cutting portions, extending from the cutting portion and formed in a winding direction.

11. A battery cell comprising:
a first electrode wound about a winding axis and comprising a first uncoated portion; a second electrode wound about the winding axis and comprises a second uncoated portion, and a separator disposed between the first electrode and the second electrode; and
a cylindrical case accommodating said electrode assembly,
wherein the first uncoated portion comprises a plurality of cutting portions, formed at a predetermined depth from an end of the first electrode, and a plurality of cross-cutting portions, extending from the cutting portions and formed in a winding direction.

12. The battery cell according to claim 11, wherein a shape formed by the cutting portion and the cross-cutting portion is a T shape or a + shape.

13. The battery cell according to claim 11, wherein a cutting depth a of the cutting portion is in the range of 2 mm or more and 7 mm or less.

14. The battery cell according to claim 11, wherein a cutting depth b of the cross-cutting portion extending from the cutting portion is in the range of 0.5 mm or more and 2.5 mm or less.

15. The battery cell according to claim 11, wherein the first uncoated portion comprises a plurality of flags partitioned by the cutting portion and the cross-cutting portion.

16. The battery cell according to claim 15, wherein the flag includes a bent portion connected to the first uncoated portion, and
wherein a width c of the bent portion is in the range of 1 mm or more and 5 mm or less.

17. The battery cell according to claim 15, wherein a ratio b/d of a cutting depth b of the cross-cutting portion extending from the cutting portion to a width d of the flag is in the range of 0.08 or more and 0.85 or less.

18. The battery cell according to claim 15, wherein a ratio c/d of a width c of the cutting portion to a width d of the flag is in the range of 0.08 or more and 0.85 or less.

19. The battery cell according to claim 15, wherein a spacing x between the flag and adjacent the flag is in the range of 100 μm or less.

20. The battery cell according to claim 11, wherein the second uncoated portion comprises a plurality of cutting portion, formed at a predetermined depth from an end of the second electrode, and a plurality of cross-cutting portions, extending from the cutting portions and formed in a winding direction.
